(19) United States
(12) Patent Application Publication
(10) Pub. No.: US 2006/0158672 A1
(43) Pub. Date: Jul. 20, 2006

(54) Patch color comparison apparatus, patch color, comparison program storage medium, and patch color comparison system

(75) Inventor: Hirokazu Kondo, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/326,338

(22) Filed: Jan. 6, 2006

(30) Foreign Application Priority Data
Jan. 18, 2005 (JP) 2005-009796

(51) Int. Cl. H04N 1/60

(52) U.S. Cl. 358/1.9

(57) ABSTRACT

In a patch color comparison apparatus, a frequency analyzer computes occurrence frequency of colors in portions of an image represented by a device-dependent color space, the color appearing in every one of plural areas of the device-dependent color space. A color patch train creator creates a color patch train where plural color patches having a color representing each of the plural areas is arranged in order of the computed occurrence frequency and associates the color patch train with the image. A color data saver obtains a reference color data where each color of the plural color patches is represented by a device-independent color space, and saves the reference color data associated with the image. A color data comparator obtains colorimetric data where each color of plural color patches constituting the color patch train is represented by the device-independent color space and compares the colorimetric data with the reference color data.

### BACKGROUND OF THE INVENTION

1. Field of the Invention

The present invention relates to a patch color comparison apparatus for performing a comparison of colors of color patches, a patch color comparison program storage medium storing a patch color comparison program, and a patch color comparison system.

2. Description of the Related Art

Recently, as a technology of an image taking apparatus, which is typically represented by a digital camera, is developed, a user of the image taking apparatus can output a color image of photography on a sheet by one self using a color printer, without asking a camera shop to do development, and thus a technology as to an image forming apparatus, which is typically represented by a color printer, has come into wide use.

It is desired that a color shade of a color image to be outputted from a color printer on a sheet is always stable not restricted to the time of the output. However, it is obliged that property of the color printer is affected by change with elapse. In view of the foregoing, there are proposed technologies wherein a color patch, which is a standard of a color shade to be outputted by the color printer, is created beforehand, and the output of the color printer involved in change with elapse is corrected in such a manner that a color shade, which is implemented by the color patch, is referred to so as to reproduce the color shade (for example, cf. Japanese Patent Application Laid Open Gazette Tokukai Hei. 10-6562, and Japanese Patent Application Laid Open Gazette Tokukai 2001-245171).

However, according to the methods disclosed in Japanese Patent Application Laid Open Gazette Tokukai Hei. 10-6562, and Japanese Patent Application Laid Open Gazette Tokukai 2001-245171, it happens that while the color shade of the color patch as a standard of the color shade is reproduce, it happens that reproduction quality is insufficient when the general color image, which is the original output object, is actually outputted. The color patch, which is used as a standard of the color shade in those methods, lacks reliability in decision of the color reproduction quality of a color printer. Further, the color patch, which is used as a standard of the color shade in those methods, lacks reliability also with respect to the standard of the color change, since it happens that the color patch changes in color shade with the passage of time.

### SUMMARY OF THE INVENTION

In view of the foregoing, it is an object of the present invention to provide a patch color comparison apparatus capable of performing a decision with high reliability when it is used for making a decision of color reproduction quality, a patch color comparison program storage medium storing a patch color comparison program, and a patch color comparison system.

To achieve the above-mentioned object, the present invention provides a patch color comparison apparatus comprising:

a frequency analyzer section that computes occurrence frequency of colors in portions of an image represented by a device color space depending on a device mediating an image and image data, wherein the color appears in every one of a plurality of areas of the device color space;

a color patch train creating section that creates a color patch train in which a plurality of color patches having a representative color representing each of the plurality of areas is arranged in order of the occurrence frequency computed by the frequency analyzer section, and establishes an association between the color patch train and the image involved in computation of the occurrence frequency;

a color data saving section that obtains a reference color data in which each color of the plurality of color patches constituting the color patch train created by the color patch train creating section is represented by a non-dependent color space that is independent of a device mediating an image and image data, and saves the reference color data through an association with the image involved in computation of the occurrence frequency; and

a color data comparison section that obtains colorimetric data in which the color patch train created by the color patch train creating section is outputted, and each color of the plurality of color patches constituting the color patch train is subjected to a colorimetry and is represented by the non-dependent color space, and compares the colorimetric data with the reference color data.

It is acceptable that the color patch train creating section creates color patch data as the color patch train.

According to the patch color comparison apparatus of the present invention, the reference color data, which is obtained from the color patch train based on the occurrence frequency of colors of an image, is established as a standard of the color shade. Thus, the correlation between the reference color data as a standard of comparison and the general image of the output object is close. Further, since the reference color data is expressed on a numerical basis using coordinate values of non-dependent color space that is independent of devices, the patch color comparison apparatus of the present invention is independent of change with elapse, as in the outputted color patch, and is high in reliability as a standard for comparison of color patches.

In the patch color comparison apparatus according to the present invention as mentioned above, it is preferable that the patch color comparison apparatus further comprises a reproduction evaluation section that evaluates a degree of color reproduction of the color patch train in accordance with a comparison result by the color data comparison section.

The use of the reproduction evaluation section makes it possible to evaluate a degree of color reproduction of the outputted color patch train, so that it is possible to check as to whether the outputted image is an image involved in a color shade of a target.

In the patch color comparison apparatus according to the present invention as mentioned above, it is preferable that the color data saving section saves a plurality of reference color data through an association with a plurality of images,

the color data comparison section compares the colorimetric data with the plurality of reference color data, and

the patch color comparison apparatus further comprises an image specifying section that specifies an image to be associated with the colorimetric data in accordance with a comparison result by the color data comparison section.

This feature makes it possible to use the color data obtained from the color patch train based on the occurrence frequency of colors of an image, as ID for specifying the image.

In the patch color comparison apparatus according to the present invention as mentioned above, it is preferable that the color data saving section obtains the reference color data from a colorimeter that measures each of the plurality of color patches.

The use of the colorimetric values of colors of the color patch as the reference color data makes it possible to obtain a standard for comparison, which is independent of change with elapse, from the color patch that is visually recognized by a user.

In the patch color comparison apparatus according to the present invention as mentioned above, it is preferable that when the color patch train creating section creates the color patch train, the color patch train creating section creates color patch data in which every color of a plurality of color patches constituting the color patch train is represented with the device color space,

the patch color comparison apparatus further comprises a reference color data creating section that creates the reference color data in accordance with a color conversion definition defining a color conversion between the device color space and the non-dependent color space, and

the color data saving section obtains the reference color data from the reference color data creating section.

The use of the reference color data, which is determined through the computation from the color patch train, makes it possible to efficiently create reference color data associated with every image, even if a large number of images is concerned.

To achieve the above-mentioned object, the present invention provides a patch color comparison program storage medium storing a patch color comparison program which causes a computer to operate as a patch color comparison apparatus, when the patch color comparison program is incorporated into the computer and is executed, the patch color comparison apparatus comprising:

a frequency analyzer section that computes occurrence frequency of colors in portions of an image represented by a device color space depending on a device mediating an image and image data, wherein the color appears in every one of a plurality of areas of the device color space;

a color patch train creating section that creates a color patch train in which a plurality of color patches having a representative color representing each of the plurality of areas is arranged in order of the occurrence frequency computed by the frequency analyzer section, and establishes an association between the color patch train and the image involved in computation of the occurrence frequency;

a color data saving section that obtains a reference color data in which each color of the plurality of color patches constituting the color patch train created by the color patch train creating section is represented by a non-dependent color space that is independent of a device mediating an image and image data, and saves the reference color data through an association with the image involved in computation of the occurrence frequency; and

a color data comparison section that obtains colorimetric data in which the color patch train created by the color patch train creating section is outputted, and each color of the plurality of color patches constituting the color patch train is subjected to a colorimetry and is represented by the non-dependent color space, and compares the colorimetric data with the reference color data.

When the patch color comparison program stored in the patch color comparison program storage medium is executed in a computer, it is possible to operate the computer as the patch color comparison apparatus.

The patch color comparison program stored in the patch color comparison program storage medium includes all the aspects corresponding to those of the patch color comparison apparatus.

With respect to the structural elements such as the frequency analyzing section constituting the patch color comparison program related to the present invention, it is acceptable that function of one structural element is implemented by one program part, function of one structural element is implemented by a plurality of program parts, or alternatively functions of a plurality structural elements are implemented by one program part. Further, it is acceptable that those structural elements are executed by oneself or by instruction to another program or program parts incorporated into a computer.

To achieve the above-mentioned object, the present invention provides a patch color comparison system comprising,

a patch color comparison apparatus comprising: a frequency analyzer section that computes occurrence frequency of colors in portions of an image represented by a device color space depending on a device mediating an image and image data, wherein the color appears in every one of a plurality of areas of the device color space; a color patch train creating section that creates a color patch train in which a plurality of color patches having a representative color representing each of the plurality of areas is arranged in order of the occurrence frequency computed by the frequency analyzer section, and establishes an association between the color patch train and the image involved in computation of the occurrence frequency; a color data saving section that obtains a reference color data in which each color of the plurality of color patches constituting the color patch train created by the color patch train creating section is represented by a non-dependent color space that is independent of a device mediating an image and image data, and saves the reference color data through an association with the image involved in computation of the occurrence frequency; and a color data comparison section that obtains colorimetric data in which the color patch train created by the color patch train creating section is outputted, and each color of the plurality of color patches constituting the color patch train is subjected to a colorimetry and is represented by the non-dependent color space, and compares the colorimetric data with the reference color data,

an image output apparatus that outputs an image in accordance with image data and also outputs a color patch train associated with the image data by the color patch train creating section of the patch color comparison apparatus, and

a colorimeter that measures every color of a plurality of color patches constituting the color patch train outputted by the image output apparatus so as to obtain colorimetric data in which the measured colors are represented by the non-dependent color space, and applies the colorimetric data to the color data comparison section of the patch color comparison apparatus.

According to the patch color comparison system of the present invention, the reference color data, which is obtained from the color patch train based on the occurrence frequency of colors of an image, is established as a standard of the color shade. Thus, the correlation between the reference color data as a standard of comparison and the general image of the output object is close. Further, since the reference color data is expressed on a numerical basis using coordinate values of non-dependent color space that is independent of devices, the patch color comparison apparatus of the present invention is independent of change with elapse, as in the outputted color patch, and is high in reliability as a standard for comparison of color patches.

### BRIEF DESCRIPTION OF THE DRAWINGS

FIG. 1 is a construction view of a patch color comparison system according to an embodiment of the present invention, to which an embodiment of a patch color comparison apparatus of the present invention is applied.

FIG. 2 is a perspective view of a server PC (personal computer) that is operative in form of an embodiment of a patch color comparison apparatus of the present invention.

FIG. 3 is a hardware structural view of the server PC shown in FIG. 2.

FIG. 4 is a view useful for understanding a patch color comparison program stored in a patch color comparison program storage medium of the present invention.

FIG. 5 is a functional block diagram of elements for operating the server PC shown in FIG. 1 and FIG. 2 in form of an embodiment of a patch color comparison apparatus of the present invention.

FIG. 6 is a flowchart useful for understanding a reference color data creation performed in the server PC shown in FIG. 1.

FIG. 7 is a flowchart useful for understanding a working wherein a system of a server side performs evaluations for reproduction quality of colors for color patches created in a system of a client side.

FIG. 8 is a flowchart useful for understanding a working wherein a system of a server side specifies an image associated with measurement color data for color patches created in a system of a client side in accordance with the measurement color data.

### DETAILED DESCRIPTION OF PREFERRED EMBODIMENTS

Embodiments of the present invention will be described with reference to the accompanying drawings.

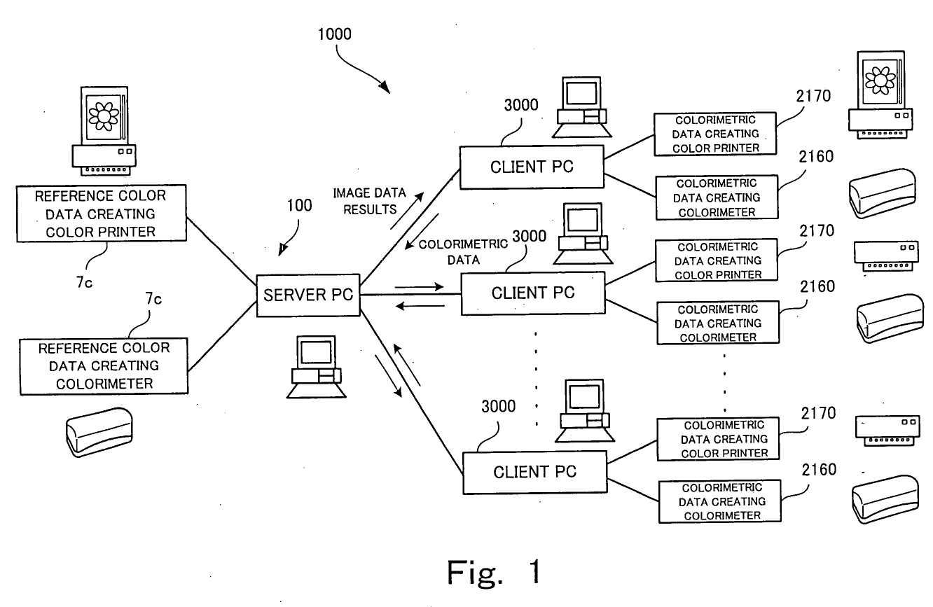

FIG. 1 is a construction view of a patch color comparison system according to an embodiment of the present invention, to which an embodiment of a patch color comparison apparatus of the present invention is applied.

A patch color comparison system 1000 comprises a server side system for performing a comparison of color patches, and a client side system for outputting color patches to perform a colorimetry of the outputted color patches.

The server side system comprises: a server personal computer (hereinafter, it is referred to as a server PC) 100 that transmits image data and color patch data representative of color patches to the client side system, and receives colorimetric color data of color patches from the client side system, so that reproduction quality of colors and identification of images are performed and the results are transmitted to the client side system; a reference color data creating color printer 7c for creating a color patch reference color data that is a standard for a comparison in comparison of color patches; and a reference color data creating colorimeter 7b for performing a colorimetry of the color patch outputted from the reference color data creating color printer 7c. The reference color data creating color printer 7c and the reference color data creating colorimeter 7b are connected to the server PC 100 so that the server PC 100 controls the operation of those units. The server PC 100 also serves as an embodiment of a patch color comparison apparatus of the present invention, while it is the server personal computer in the patch color comparison system 1000 of the present embodiment.

On the other hand, the client side system comprises: a colorimetric data creating color printer 2170 for outputting color patches; a colorimetric data creating colorimeter 2160 for measuring the outputted color patch; and a client personal computer (hereinafter, it is referred to as a client PC) 3000 that receives image data and color patch data transmitted from,the server side system, and causes the colorimetric data creating color printer 2170 to output an image according to the image data and a color patch according to the color patch data, and causes the colorimetric data creating colorimeter 2160 to measure the outputted color patch, so that colorimetric data, which is obtained from results, is transmitted to the server side system. According to the patch color comparison system 1000 of the present embodiment, there exist a plurality of clients each having the colorimetric data creating color printer 2170, the colorimetric data creating colorimeter 2160, and the client PC 3000, as shown in FIG. 1. Those clients are connected to the server PC 100 through a LAN (Local Area Network).

Hereinafter, in the patch color comparison system 1000 comprising the server side system and the client side system, there will be explained the server PC 100 which serves as a patch color comparison apparatus of the present embodiment, and also serves as a server computer.

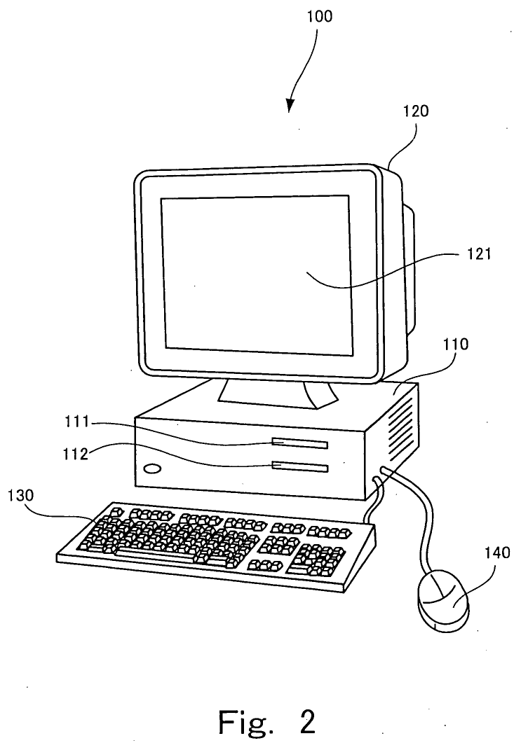

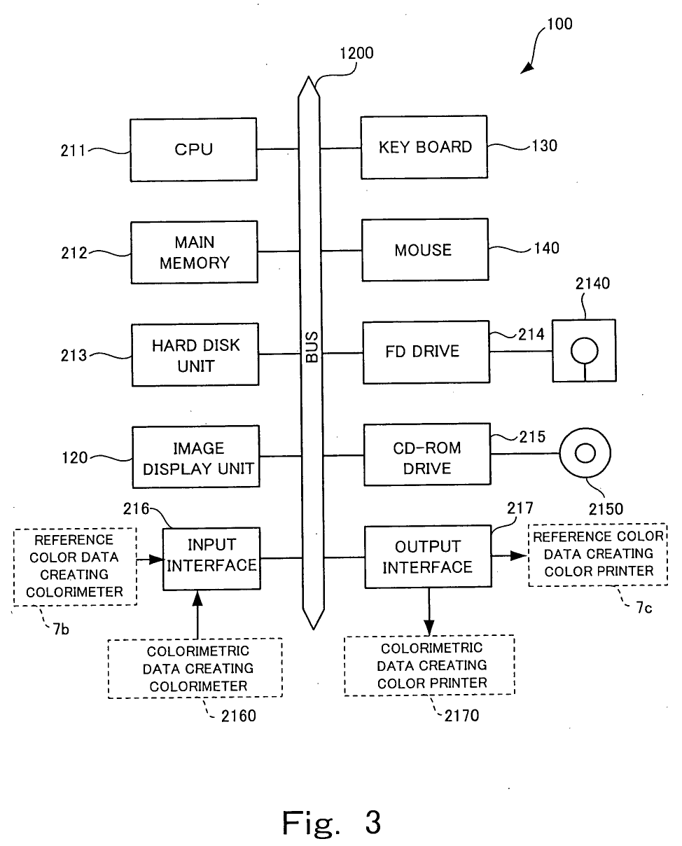

FIG. 2 is a perspective view of a server PC (personal computer) that is operative in form of an embodiment of a patch color comparison apparatus of the present invention. FIG. 3 is a hardware structural view of the server PC shown in FIG. 2.

The server PC 100 comprises, on an external appearance, a main frame unit 110 incorporating therein a CPU, a RAM memory, a hard disk and the like, an image display unit 120 for displaying an image on a display screen 121 in accordance with an instruction from the main frame unit 110, a keyboard 130 for inputting various sorts of information such as user's instruction and character information to the main frame unit 51 in accordance with a key operation, and a mouse 140 for inputting an instruction according to, for example, an icon and the like, through designation of an optional position on the display screen 121, the icon and the like being displayed on the position on the display screen 121.

The main frame unit 110 has a flexible disk-mounting slot 111 for mounting a flexible disk (FD), and a CD-ROM mounting slot 112 for mounting a CD-ROM. Inside of the main frame unit 110, there are provided a FD drive and a CD-ROM, which drive the mounted FD and CD-ROM, respectively.

The main frame unit 110 comprises, as shown in FIG. 3, a CPU 211 for executing a various types of program, a main memory 212 in which a program stored in a hard disk unit 213 is read out and developed for execution by the CPU 211, the hard disk unit 213 for saving various types of programs and data, a flexible disk (FD) drive 214 for accessing a flexible disk 2140 mounted thereon, and a CD-ROM drive 215 for accessing a CD-ROM 2150 mounted thereon. These various types of elements are connected via a bus 1200 to the image display unit 120, the keyboard 130 and the mouse 140. Outside the server PC 100, there are provided the reference color data creating color printer 7c for creating a color patch reference color data that is a standard for a comparison in comparison of color patches, and the colorimetric data creating color printer 2170 for outputting color patches for the colorimeter as the comparison object. The server PC 100 incorporates therein an output interface 217 to transmit output data from the server PC 100 to the reference color data creating color printer 7c and the colorimetric data creating color printer 2170. Outside the server PC 100, there are further provided the reference color data creating colorimeter 7b for measuring a color patch for a reference, and the colorimetric data creating colorimeter 2160 for measuring a color patch as the comparison object as well as the reference color data creating color printer 7c and the colorimetric data creating color printer 2170. The server PC 100 incorporates therein an input interface 216 to input colorimetric data from the reference color data creating colorimeter 7b and the colorimetric data creating colorimeter 2160 to the server PC 100. When the input interface 216 is used to connect external equipment such as a scanner (not illustrated) to the server PC 100, it is possible to input image data that is the base of color patch data in the event that a color patch is created. Actually, as shown in FIG. 1, connected to the output interface 217 and the input interface 216 are a plurality of colorimetric data creating color printers 2170 and a plurality of colorimetric data creating colorimeters 2160 via the client PC 3000, respectively. In FIG. 3, however, typically, there are shown a single colorimetric data creating color printer 2170 and a single colorimetric data creating colorimeter 2160. The output interface 217 and the input interface 216 are also connected via the bus 1200 to the above-mentioned various elements, which constitute the hardware of the server PC 100.

According to the present embodiment, the site, in which a color patch as a comparison object is outputted and measured, is located far from places at which the server PC 100, the reference color data creating colorimeter 7b, and the reference color data creating color printer 7c are located. Therefore, according to the present embodiment, it is assumed that there is a need to use individual colorimeters for the reference color data creating colorimeter 7b and the colorimetric data creating colorimeter 2160. However, in the event that the site, in which a color patch as a comparison object is outputted and measured, is located near places at which the server PC 100, the reference color data creating colorimeter 7b, and the reference color data creating color printer 7c are located, it is acceptable that the colorimetric data creating colorimeter 2160 also serves as the reference color data creating colorimeter 7b. Further, according to the present embodiment, in the event that color patches, which are mutually different in timing of the output from the colorimetric data creating color printer 2170, are compared with one another, it is possible to apply the embodiment of a patch color comparison apparatus of the present invention to a use in which change with elapse of the reproduction ability of the colorimetric data creating color printer 2170 is investigated. In case of this application, the colorimetric data creating color printer 2170 also serves as the reference color data creating color printer 7c.

According to the server PC 100, a user of the server PC 100 can save into a hard disk unit 213 image data, on which a color patch is based when the color patch is created, through entry of the same from the input interface 216. Also the user of the server PC 100 can save the image data from the FD 2140 and the CD-ROM 2150, which store the image data, via the FD drive 214 and the CD-ROM drive 215, respectively, into the hard disk unit 213. According to the server PC 100, which serves as the patch color comparison apparatus of the present embodiment, the image data, on which a color patch is based when the color patch is created, is the image data saved into the hard disk unit 213 in the manner as mentioned above. However, it is acceptable that the patch color comparison apparatus of the present invention uses the image data saved in the FD 2140 and the CD-ROM 2150, which are mounted on the FD drive 214 and the CD-ROM drive 215, respectively, but not restricted to the hard disk unit 213.

Next, there will be explained an embodiment of a patch color comparison program storage medium storing a patch color comparison program, of the present invention.

In the event that the patch color comparison program is stored in, for example, the CD-ROM 2150, when the CD-ROM 2150 is mounted on the main frame 110 through the CD-ROM mounting slot 112, the CD-ROM drive 215 installs the patch color comparison program stored in the CD-ROM 2150 in the hard disk unit 213 of the server PC 100. When the patch color comparison program installed in the hard disk unit 213 is activated, the server PC 100 serves as an embodiment of the patch color comparison apparatus of the present invention.

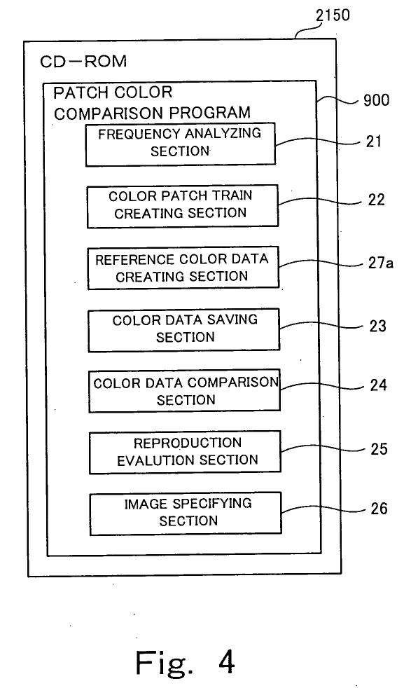

FIG. 4 is a view useful for understanding a patch color comparison program stored in a patch color comparison program storage medium of the present invention.

The CD-ROM 2150 stores therein a patch color comparison program 900. As the storage medium storing the patch color comparison program 900, it is possible to adopt various types of storage medium such as not only the CD-ROM 2150 and the hard disk unit 213 but also the FD 2150 and DVD and MO (not illustrated in FIG. 3).

The patch color comparison program 900 is executed in the server PC 100 shown in FIG. 2 and FIG. 3 so as to cause the server PC 100 to serve as an embodiment of the present invention, as mentioned above. The patch color comparison program 900 comprises a frequency analyzer section 21, a color patch train creating section 22, a color data saving section 23, a color data comparison section 24, a reproduction evaluation section 25, an image specifying section 26, and a reference color data creating section 27a.

Details of contents of every element of the patch color comparison program 900 will be described later.

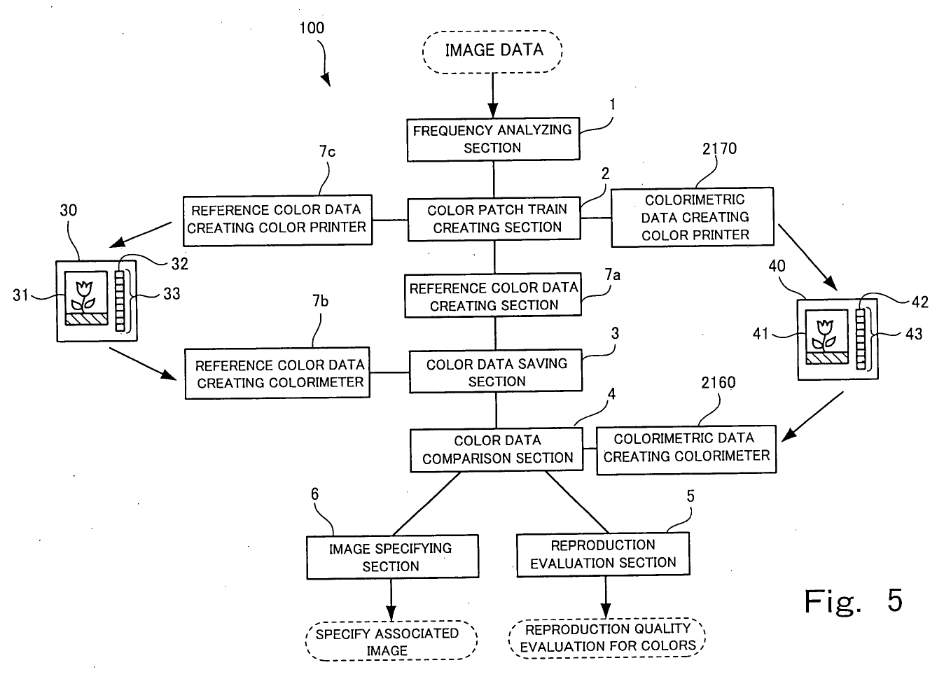

FIG. 5 is a functional block diagram of elements for operating the server PC shown in FIG. 1 and FIG. 2 in form of an embodiment of a patch color comparison apparatus of the present invention.

When the patch color comparison program 900 shown in FIG. 4 is installed in the server PC 100 shown in FIG. 2 and FIG. 3, constructed on the server PC 100 are a frequency analyzer section 1, a color patch train creating section 2, a color data saving section 3, a color data comparison section 4, a reproduction evaluation section 5, an image specifying section 6, and a reference color data creating section 7a, which are shown in FIG. 5, so that the patch color comparison program 900 causes the server PC 100 to serve as an embodiment of a patch color comparison apparatus of the present invention. The frequency analyzer section 1, the color patch train creating section 2, the color data saving section 3, the color data comparison section 4, the reproduction evaluation section 5, the image specifying section 6, and the reference color data creating section 7a are constructed on the server PC 100 by the frequency analyzer section 21, the color patch train creating section 22, the color data saving section 23, the color data comparison section 24, the reproduction evaluation section 25, the image specifying section 26, and the reference color data creating section 27a, of the patch color comparison program 900 shown in FIG. 4, respectively. Accordingly, all the elements of FIG. 4 correspond to the associated elements of FIG. 5, respectively. However, the elements of FIG. 5 are different from the elements of FIG. 4 in the following point. The elements of FIG. 5 are constructed by a combination of the hardware of the server PC 100 shown in FIG. 1 and FIG. 2 and an OS and an application program, which are executed in the server PC 100. On the other hand, the elements of the patch color comparison program 900 shown in FIG. 4 are constructed by only the application program.

Hereinafter, there will be explained all the elements shown in FIG. 5 and the functions of the elements.

First, the frequency analyzer section 1 computes occurrence frequency of colors for an image represented by the image data for the processing object. Next, the color patch train creating section 2 creates color patch data representative of a color patch train consisting of color patches in such a manner that coordinate values of the RGB color space representative of the colors are arranged in order of the computed occurrence frequency, and establishes an association between the color patch data and the image that is the basis of the color patch data. Since the color patch data is represented by the RGB color space depending on the associated output device, it is convenient that the color patch data is converted into color data for reference represented by a color space independent of the associated output device so as that it is convenient even when both the color patches, which are outputted from the mutually different devices, are compared with one another. The server PC 100, which serves as the patch color comparison apparatus of the present embodiment, is provided with two ways as a method of converting the color patch data into color data for reference. A user of the server PC 100 may optionally select any one of the two ways.

One of the two ways is a method in which the reference color data creating color printer 7c is used to output the color patch data, and the reference color data creating colorimeter 7b is used to measure a train of the outputted color patches, so that there is obtained reference color data consisting of trains of colorimetric values represented by the Lab color space independent of the associated output device. For example, on an output sheet 30 in FIG. 5, there is outputted a color patch train 33 consisting of color patches 32 arranged in order of occurrence frequency of colors appearing in an image 31 at the side of the image 31. A colorimetry of the color patch train 33 makes it possible to obtain the reference color data consisting of a train of the colorimetric values associated with the image 31. The reference color data according to this method has such an advantage that it is possible to obtain a comparison reference having no effect on change with elapse from the color patch through user's visual confirmation.

Another of the ways is a method in which the printer file of the reference color data creating color printer 7c is used to convert the color patch data into a train of the coordinate values represented by the Lab color space. According to this method, since the reference color data is computed through the conversion work on the server PC 100, it is possible to efficiently create the reference color data associated with the respective image even if many images are concerned.

The color data saving section 3 saves the obtained reference color data through association with the image as the basis of the reference color data even if the reference color data is obtained through any way.

The color patch data created by the color patch train creating section 2 is transmitted to the colorimetric data creating color printer 2170 to output the color patch train associated with the color patch data. When the colorimetric data creating colorimeter 2160 measures the outputted color patch train, it is possible to obtain colorimetric data of the comparison object, which consists of a train of colorimetric values represented by the Lab color space. For example, on an output sheet 40 in FIG. 5, there is outputted a color patch train 43 consisting of color patches 42 arranged in order of occurrence frequency of colors appearing in an image 41 at the side of the image 41. A colorimetry of the color patch train 43 makes it possible to obtain the colorimetric data associated with the image 41. The thus obtained colorimetric data is transmitted to the color data comparison section 4 so as to perform a comparison of the colorimetric data of the comparison object with the reference color data saved through the association with the image by the color data saving section 3.

The reproduction evaluation section 5 evaluates as to whether the color patch train outputted from the colorimetric data creating color printer 2170 reproduces a desired color in accordance with the comparison result, so that property of the colorimetric data creating color printer 2170 as to reproduction for colors is investigated through the evaluation.

In the event that there is a need to specify the image associated with the colorimetric data in accordance with the colorimetric data, for example, in a case where images and image data are lost owing to accident and the like, the color data comparison section 4 performs a comparison of the colorimetric data with the reference color data saved through the association with the image by the color data saving section 3. Upon receipt of the comparison result, the image specifying section 6 specifies the image as the basis of the colorimetric data.

The above description is concerned with the explanation of all the elements shown in FIG. 5 and the functions of the elements. Details of the functions of the elements will be described in conjunction with the explanation of the flowchart of a patch color comparison system of the present invention.

In the above explanation, the frequency analyzer section 1, the color patch train creating section 2, the color data saving section 3, the color data comparison section 4, the reproduction evaluation section 5, and the image specifying section 6 correspond to the frequency analyzer section, the color patch train creating section, the color data saving section, the color data comparison section, the reproduction evaluation section, and the image specifying section, of the patch color comparison apparatus of the present invention, respectively.

Hereinafter, there will be explained an operation of the patch color comparison system 1000 shown in FIG. 1 using a flowchart. In conjunction with the explanation of the operation of the patch color comparison system 1000, there will be explained details of the functions of the elements, which are constructed on the server PC 100 that serves as an embodiment of the patch color comparison apparatus of the present embodiment.

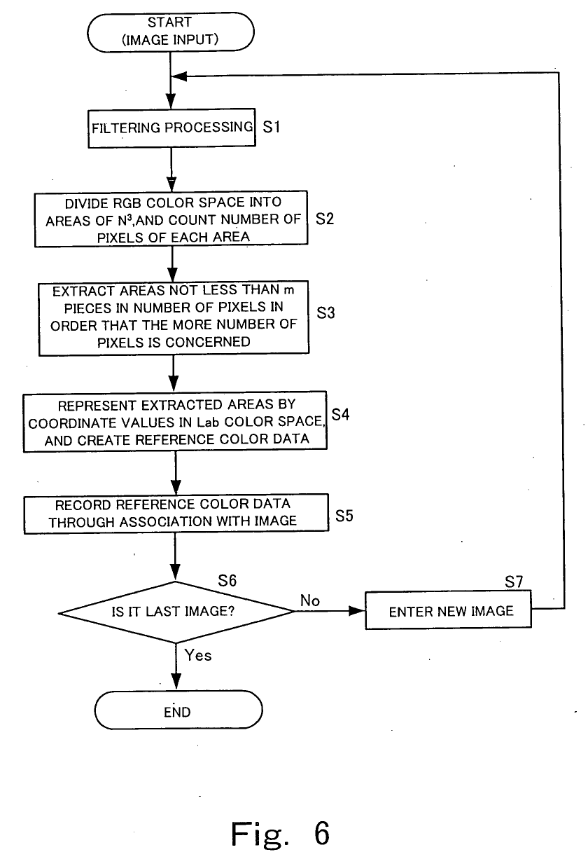

FIG. 6 is a flowchart useful for understanding a reference color data creation performed in the server PC shown in FIG. 1.

The server PC 100 reads image data through the hard disk unit 213 shown in FIG. 3 and starts processing for an image represented by the image data thus read as the object of the reference color data creation. First, in step S1, there is performed filtering processing in which Gaussian filter, which approximates frequency characteristics of visual sensation of a human, is applied to the image of the entered processing object so that the processing is simplified and a space frequency, which is easy to sense by visual sensation of a human, is enhanced. And there is performed a work that resolution of the outputted image is lowered by about 25 to 120 dpi. Next, there are investigated coordinate values of the pixels in the RGB color space in the image to which the filtering processing is applied. In step S2, three color directions of R, G and B of the RGB color space are each divided into N-pieces of areas so that the whole of the RGB color space is divided into N×N×N pieces of areas, and the number of pixels having coordinate values belonging to each area of N×N×N pieces of areas are counted on each area. And the frequency analyzer section 1 shown in FIG. 5 extracts areas not less than m pieces in the number of pixels in order that the more number of pixels is concerned (step S3). Accordingly, in the event that the number of areas thus extracted is M pieces, the area of M pieces represents M color which is high in occurrence frequency of the color appearing in the image, and the value of M represents tendency of distribution of the number of pixels in the image. Thus, the area of M pieces thus extracted reflects characteristic of the image. Next, the color patch train creating section 2 arranges the coordinate values in the RGB color space, which represents the extracted areas, in order that the more number of pixels belonging to the respective area so that color patch data for a color patch creation is created, and thus created color patch data is associated with the image as the basis of the color patch data. Subsequently, reference color data, which is represented in the Lab space, is created in accordance with the created color patch data (step S4). As explained in conjunction with FIG. 5, there are two ways as to a method of creating the reference color data. A user of the server PC 100 may optionally select any one of the two ways. The color data saving section 3 saves the created reference color data through an association with the image (step S5). Next, in step S6, it is decided as to whether the image associated with the created reference color data is the last image to be processed. When it is decided that the image of interest is not the last image, the process goes to step S7 in which a new image is inputted and returns to the step S1 to carry out works of the steps S1 to S5 as explained above for the new image. In the step S6, it is decided that the image associated with the created reference color data is the last image to be processed, the work for creating the reference color data is terminated.

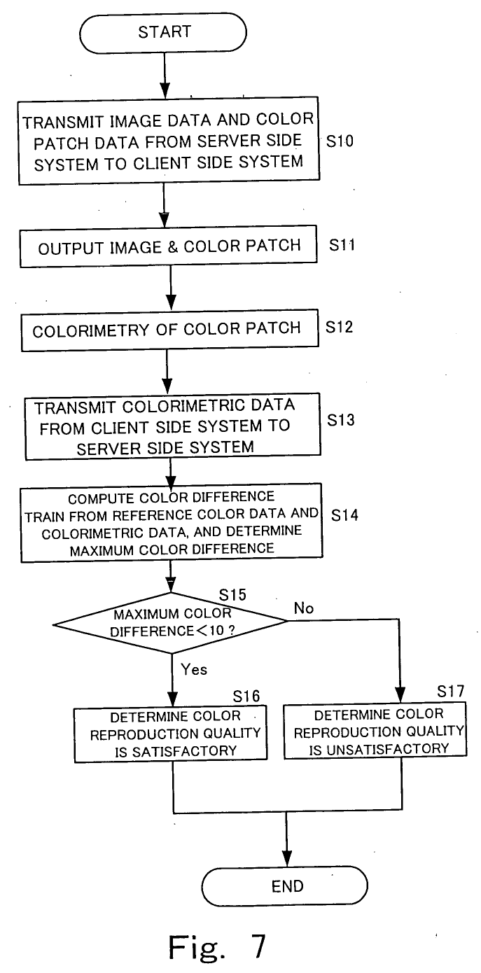

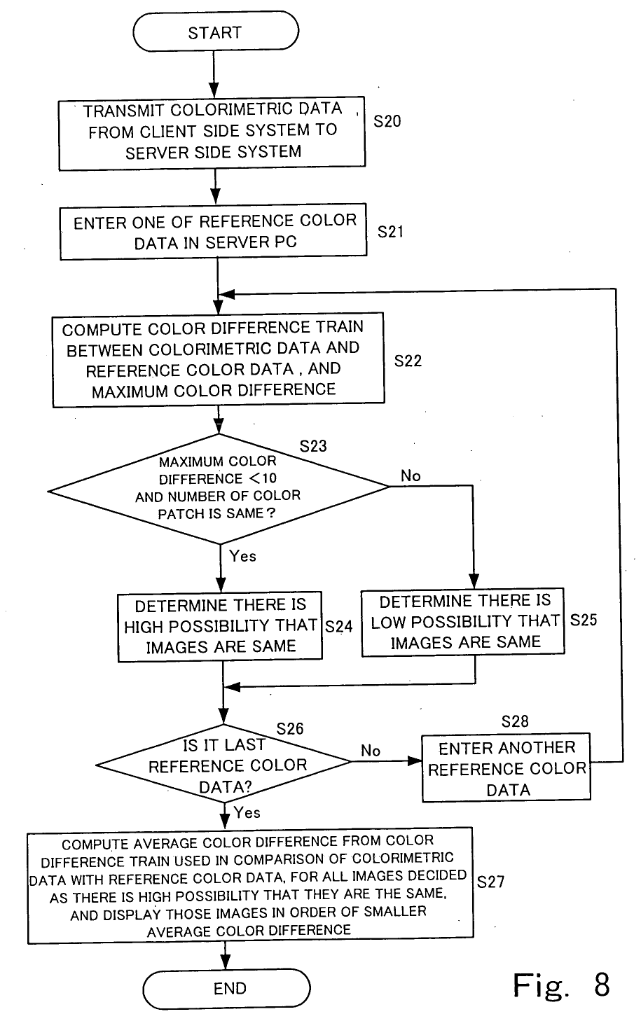

Next, there will be explained a flow of a comparison work of color patches using the reference color data explained with reference to FIG. 5 in conjunction with the patch color comparison system 1000. Hereinafter, first, there will be explained a flow of a work wherein an evaluation of reproduction quality of colors is performed in accordance with the comparison work as mentioned above, in conjunction with the flowchart of FIG. 7, and then there will be explained a flow of a work wherein specifying of an image is performed in accordance with the comparison work as mentioned above, in conjunction with the flowchart of FIG. 8.

FIG. 7 is a flowchart useful for understanding a working wherein a system of a server side performs evaluations for reproduction quality of colors for color patches created in a system of a client side.

As mentioned in conjunction with FIG. 6, the color patch data, which is created by the color patch train creating section 2 of the server PC 100, is transmitted together with the associated image to the client PC 3000 shown in FIG. 1 of the client side system (step S10). And the color patch based on the color patch data is outputted together with the image as explained in conjunction with FIG. 5 from the colorimetric data creating color printer 2170 shown in FIG. 1 via the client PC 3000 (step S11). And when the colorimetric data creating colorimeter 2160 shown in FIG. 1 of the client side system measures the outputted color patch, there is obtained colorimetric data of the comparison object, which consists of a series of colorimetric values represented by the Lab color space (step S12). The thus obtained colorimetric data is transmitted from the client side system via the client PC 3000 to the server PC 100 of the server side system (step S13). In the server side system, upon receipt of the colorimetric data of the color patch, the color data comparison section 4 shown in FIG. 5 computes a color difference train consisting of color differences, or differences of chromaticity values, from the difference between the colorimetric data as the comparison object and the reference color data that is saved through an association with the image by the color data saving section 3, and determines the maximum color difference that offers the maximum value in the color difference train (step S14). The reproduction evaluation section 5 shown in FIG. 4 decides as to whether the determined maximum color difference is smaller than 10 (step S15). In the event that it is decided that the maximum color difference is smaller than 10, the reproduction evaluation section 5 provides for an image outputted from the colorimetric data creating color printer 2170 of the client side system such an evaluation that reproduction quality of color is satisfactory on a basis of an image that is saved in the server side system, and causes the color data saving section 3 to save the evaluation result through an association with the image (step S16). Thus the work of performing the evaluation of the color reproduction quality is terminated. In the step S15, when the maximum color difference is larger than 10, the reproduction evaluation section 5 provides for an image outputted from the colorimetric data creating color printer 2170 of the client side system such an evaluation that reproduction quality of color is unsatisfactory on a basis of an image that is saved in the server side system, and causes the color data saving section 3 to save the evaluation result through an association with the image (step S17). Thus the evaluation result is transmitted to the client side system, and the work of performing the evaluation of the color reproduction quality is terminated.

The above mentioned description is concerned with the explanation for the work that the server side system performs an evaluation of reproduction quality of color for the color patch created in the client side system. Next, there will be explained a flow of a work wherein an image is specified.

FIG. 8 is a flowchart useful for understanding a working wherein a system of a server side specifies an image associated with measurement color data for color patches created in a system of a client side in accordance with the measurement color data.

In the event that there is a need to specify the image associated with the colorimetric data in accordance with the colorimetric data, for example, in a case where images and image data are lost owing to accident and the like in the client side system, the following work of specifying the image is carried out. First, the client PC 3000 of the client side system transmits colorimetric data of color patches to the server PC 100 of the server side system (step S20). In the server PC 100 of the server side system, the color data comparison section 4 derives one reference color data from among a plurality of reference color data, which are saved by the color data saving section 3 through an association with the image, as explained in conjunction with FIG. 6, so that the reference color data is compared with the transmitted colorimetric data of color patches (step S21). In step S22, there are computed a color difference train and the maximum color difference in the color difference train in accordance with the difference between the colorimetric data of color patches and the derived reference color data. Next, in step S23, it is decided as to whether the computed maximum color difference is smaller that 10, and whether the number of color patches, that is, the number of components of the chromaticity value train of every color data is equal to one another (step S23). When it is decided that the maximum color difference is smaller that 10 and the number of color patches is equal to one another, the image specifying section 6 decides that there is a high possibility that the image associated with the colorimetric data is the same as the image associated with the derived reference color data (step S24). The color data saving section 3 records the result of decision. In the event that the maximum color difference is not less than 10, or the number of color patches is different from one another, the image specifying section 6 decides that there is a low possibility that the image associated with the colorimetric data is the same as the image associated with the derived reference color data (step S25). In step S26, it is decided whether the derived reference color data is the last reference color data, which is not subjected to the comparison works of the step S22 to the step S25, of the reference color data saved through an association with the image. In the event that it is decided that the derived reference color data is the last reference color data, which is not subjected to the comparison works of the step S22 to the step S25, of the reference color data saved through an association with the image, the image specifying section 6 computes an average color difference from the color difference train that is used in comparison of the colorimetric data with reference color data, for all the images decided as there is a high possibility that they are the same through the comparison works of the step S22 to the step S24, and displays those images in order of the smaller average color difference (step S27). And the information of the displayed image and the displayed order together are transmitted to the client side system, and the specifying work for the image is terminated. In the step S26, when it is decided that the derived reference color data is not the last reference color data, which is not subjected to the comparison works of the step S22 to the step S25, of the reference color data saved through an association with the image, a different reference color data is entered to compare it with the colorimetric data (step S28), and the process returns to the step S22 in which the comparison works of the step S22 to the step S25 are performed on the different reference color data newly entered.

The above description is concerned with the explanation for the work of specifying images.

As explained in conjunction with FIG. 6, FIG. 7 and FIG. 8, according to the patch color comparison apparatus and the patch color comparison system of the present embodiment, since the reference color data, which is obtained from the color patch train based on the occurrence frequency of colors of images, is established as a standard of the color shade, a correlation between the reference color data as a standard of comparison and the image of the output object is close. Further, since the reference color data is expressed on a numerical basis using coordinate values of non-dependent color space that is independent of devices, the patch color comparison apparatus and the patch color comparison system of the present embodiment are independent of change with elapse, as in the outputted color patch, and is high in reliability as a standard for comparison of color patches. Thus, it is possible to perform a check of reproduction quality of colors of images to be outputted, and specifying of images through the comparison.

According to the patch color comparison apparatus and the patch color comparison system of the present embodiment, as the evaluation of the color reproduction quality, there is performed a two-stage of evaluation as to whether the color reproduction quality is sufficient or insufficient on the image outputted in accordance with a decision as to whether the maximum color difference is less than 10 or not less than 10. However, it is acceptable that the patch color comparison apparatus and the patch color comparison system of the present invention are provided with further evaluation standard to establish evaluation of plural-stage of color reproduction quality more than two-stage of color reproduction quality. It is acceptable that there is provided such an evaluation that for example, if the maximum color difference is less than 10, it is decided that “A” decision is established, if the maximum color difference is less than 13 and not less than 10, it is decided that “B” decision is established, and if the maximum color difference is not less than 13, it is decided that the color reproduction quality is insufficient on the image.

Further, according to the patch color comparison apparatus and the patch color comparison system of the present embodiment, as a standard of the evaluation of the color reproduction quality and a standard of specifying images, there are used the maximum color difference and the average color difference. However, according to the patch color comparison apparatus and the patch color comparison system of the present invention, it is acceptable to adopt a weighting color difference weighted in accordance with a distribution of the color difference other than statistical amount of the color difference. It is acceptable that for example, a larger weight is applied to the color difference obtained from the upper significant chromaticity value in occurrence frequency, as compared with the color difference obtained from the lower significant chromaticity value, so that the weighted color difference, which reflects the occurrence frequency of colors, is used as a standard for the evaluation of the color reproduction quality and specifying of images.

As mentioned above, according to the patch color comparison apparatus, the patch color comparison program storage medium storing a patch color comparison program, and the patch color comparison system, of the present invention, it is possible to give a high decision in reliability when they are used in decision of color reproduction quality.

While the present invention has been described with reference to the particular illustrative embodiments, it is not to be restricted by those embodiments but only by the appended claims. It is to be appreciated that those skilled in the art can change or modify the embodiments without departing from the scope and sprit of the present invention.

What is claimed is:

1. A patch color comparison apparatus comprising:
a frequency analyzer section that computes occurrence frequency of colors in portions of an image represented by a device color space depending on a device mediating an image and image data, wherein the color appears in every one of a plurality of areas of the device color space;
a color patch train creating section that creates a color patch train in which a plurality of color patches having a representative color representing each of the plurality of areas is arranged in order of the occurrence frequency computed by the frequency analyzer section, and establishes an association between the color patch train and the image involved in computation of the occurrence frequency;
a color data saving section that obtains a reference color data in which each color of the plurality of color patches constituting the color patch train created by the color patch train creating section is represented by a non-dependent color space that is independent of a device mediating an image and image data, and saves the reference color data through an association with the image involved in computation of the occurrence frequency; and
a color data comparison section that obtains colorimetric data in which the color patch train created by the color patch train creating section is outputted, and each color of the plurality of color patches constituting the color patch train is subjected to a colorimetry and is represented by the non-dependent color space, and compares the colorimetric data with the reference color data.

2. A patch color comparison apparatus according to claim 1, wherein the patch color comparison apparatus further comprises a reproduction evaluation section that evaluates a degree of color reproduction of the color patch train in accordance with a comparison result by the color data comparison section.

3. A patch color comparison apparatus according to claim 1, wherein the color data saving section saves a plurality of reference color data through an association with a plurality of images,
the color data comparison section compares the colorimetric data with the plurality of reference color data, and
the patch color comparison apparatus further comprises an image specifying section that specifies an image to be associated with the colorimetric data in accordance with a comparison result by the color data comparison section.

4. A patch color comparison apparatus according to claim 1, wherein the color data saving section obtains the reference color data from a colorimeter that measures each of the plurality of color patches.

5. A patch color comparison apparatus according to claim 1, wherein when the color patch train creating section creates the color patch train, the color patch train creating section creates color patch data in which every color of a plurality of color patches constituting the color patch train is represented with the device color space,
the patch color comparison apparatus further comprises a reference color data creating section that creates the reference color data in accordance with a color conversion definition defining a color conversion between the device color space and the non-dependent color space, and
the color data saving section obtains the reference color data from the reference color data creating section.

6. A patch color comparison program storage medium storing a patch color comparison program which causes a computer to operate as a patch color comparison apparatus, when the patch color comparison program is incorporated into the computer and is executed, the patch color comparison apparatus comprising:
a frequency analyzer section that computes occurrence frequency of colors in portions of an image represented by a device color space depending on a device mediating an image and image data, wherein the color appears in every one of a plurality of areas of the device color space;
a color patch train creating section that creates a color patch train in which a plurality of color patches having a representative color representing each of the plurality of areas is arranged in order of the occurrence frequency computed by the frequency analyzer section, and establishes an association between the color patch train and the image involved in computation of the occurrence frequency;
a color data saving section that obtains a reference color data in which each color of the plurality of color patches constituting the color patch train created by the color patch train creating section is represented by a non-dependent color space that is independent of a device mediating an image and image data, and saves the reference color data through an association with the image involved in computation of the occurrence frequency; and
a color data comparison section that obtains colorimetric data in which the color patch train created by the color patch train creating section is outputted, and each color of the plurality of color patches constituting the color patch train is subjected to a colorimetry and is represented by the non-dependent color space, and compares the colorimetric data with the reference color data.

7. A patch color comparison system comprising,
a patch color comparison apparatus comprising: a frequency analyzer section that computes occurrence frequency of colors in portions of an image represented by a device color space depending on a device mediating an image and image data, wherein the color appears in every one of a plurality of areas of the device color space; a color patch train creating section that creates a color patch train in which a plurality of color patches having a representative color representing each of the plurality of areas is arranged in order of the occurrence frequency computed by the frequency analyzer section, and establishes an association between the color patch train and the image involved in computation of the occurrence frequency; a color data saving section that obtains a reference color data in which each color of the plurality of color patches constituting the color patch train created by the color patch train creating section is represented by a non-dependent color space that is independent of a device mediating an image and image data, and saves the reference color data through an association with the image involved in computation of the occurrence frequency; and a color data comparison section that obtains colorimetric data in which the color patch train created by the color patch train creating section is outputted, and each color of the plurality of color patches constituting the color patch train is subjected to a colorimetry and is represented by the non-dependent color space, and compares the colorimetric data with the reference color data,
an image output apparatus that outputs an image in accordance with image data and also outputs a color patch train associated with the image data by the color patch train creating section of the patch color comparison apparatus, and
a colorimeter that measures every color of a plurality of color patches constituting the color patch train outputted by the image output apparatus so as to obtain colorimetric data in which the measured colors are represented by the non-dependent color space, and applies the colorimetric data to the color data comparison section of the patch color comparison apparatus.
